(19) United States
(12) Patent Application Publication
(10) Pub. No.: US 2025/0153690 A1
(43) Pub. Date: May 15, 2025

(54) ATTITUDE CONTROL DEVICE FOR VEHICLE

(71) Applicant: MITSUBISHI JIDOSHA KOGYO KABUSHIKI KAISHA, Tokyo (JP)

(72) Inventor: Wei Te YEH, Tokyo (JP)

(73) Assignee: MITSUBISHI JIDOSHA KOGYO KABUSHIKI KAISHA, Tokyo (JP)

(21) Appl. No.: 18/837,910

(22) PCT Filed: Mar. 17, 2023
(86) PCT No.: PCT/JP2023/010604

§ 371 Date: Aug. 13, 2024

(30) Foreign Application Priority Data
Mar. 30, 2022 (JP) 2022-056094

(51) Int. Cl. B60T 8/1755

(52) U.S. Cl. CPC B60T 8/17551; B60T 8/17554

(57) ABSTRACT

An attitude control device for a vehicle, provided in a vehicle 1 having front, rear, left, and right wheels 3a to 3d suspended by a suspension device 11 that has an anti-dive and anti-lift geometry, the attitude control device including: brake devices 30a to 30d provided for the respective wheels 3a to 3d; a brake control unit 31 that operates and controls the front, rear, left, and right brake devices 30a to 30d; wheel speed sensors 33a to 33d that detect respective rotation speeds of the wheels 3a to 3d; a longitudinal acceleration sensor 35 that detects a longitudinal acceleration of the vehicle 1; a pitch and roll determination unit 40 that determines pitch and roll states of the vehicle 1 based on the rotation speed of each of the wheels 3a to 3d and the longitudinal acceleration of the vehicle 1; and an additional braking force calculation unit 41 that calculates braking force to be added by each of the brake devices 30a to 30d so as to restrain the determined pitch and roll.

### TECHNICAL FIELD

The present invention relates to an attitude control technology for a vehicle using a brake device.

### BACKGROUND ART

As a technology to stabilize the attitude of a vehicle during traveling on an uneven load to enhance the comfort of passengers, a method involving use of a four-wheel active suspension device is known. The four-wheel active suspension device controls reaction force of a suspension device of each wheel to control the attitude of the vehicle. However, there is a problem that the four-wheel active suspension device is relatively expensive. Accordingly, for vehicles without the four-wheel active suspension device, an attitude control device has been proposed which controls the braking force (brake force) of four wheels using anti-dive force and anti-lift force in the suspension device.

For example, in Patent Document 1, when at the time of turning travel of a vehicle, deviation between a target yaw rate and an actual yaw rate of the vehicle is beyond a prescribed value and a time change rate of the deviation is beyond a prescribed value, it is possible to improve turning behavior of the vehicle by adding braking force to the wheels inside the turning.

### PRIOR ART DOCUMENT

### Patent Document

Patent Document 1: Japanese Patent Laid-Open No. 2020-50024

### SUMMARY OF THE INVENTION

### Problems to be Solved by the Invention

In Patent Document 1, the yaw rate of the vehicle is controlled by controlling the braking forces of the four wheels. However, there is a demand for devices that can also control pitch and roll at low cost. At the time of controlling the attitude of the vehicle in particular, it is necessary to detect the attitude of the vehicle. However, the vehicles without the four-wheel active suspension device often have no stroke sensors in the suspension device, which makes it difficult to detect the attitude of the vehicle.

The present invention has been made in view of such problems and an object of the present invention is to provide, for a vehicle having no stroke sensor in a suspension device, an attitude control device for a vehicle that controls pitch and roll by controlling the braking force of the four wheels in accordance with the attitude of the vehicle.

### Means for Solving the Problems

In order to accomplish the object, an attitude control device for a vehicle of the present invention, provided in a vehicle having front, rear, left, and right wheels suspended by a suspension device that has an anti-dive and anti-lift geometry, the attitude control device including: braking devices provided for the respective front, rear, left, and right wheels; a braking control unit that operates and controls the front, rear, left, and right braking devices to allow addition of braking force independently to the front, rear, left, and right wheels; speed detection units that detect respective rotation speeds of the front, rear, left, and right wheels; and a longitudinal acceleration detection unit that detects a longitudinal acceleration of the vehicle, in which the braking control unit includes a pitch and roll determination unit that determines pitch and roll states of the vehicle based on the rotation speed of each of the wheels and the longitudinal acceleration of the vehicle, and a pitch and roll control unit that controls each of the front, rear, left, and right braking devices to add braking force based on the pitch and roll states.

Thus, the pitch and roll states of the vehicle are determined based on the rotation speed of each of the wheels and the longitudinal acceleration of the vehicle, and each of the front, rear, left, and right braking devices adds braking force to cancel out the pitch and roll states. Therefore, it is possible to reduce the pitch and roll based on detection information detected by relatively inexpensive detection units, such as the speed detection units and the longitudinal acceleration detection unit.

Preferably, when the pitch and roll determination unit determines the pitch or roll state of the vehicle that is equal to or more than a prescribed level while the vehicle is traveling, the pitch and roll control unit may keep on adding the braking force by the braking devices based on the pitch and roll states for a prescribed time.

Accordingly, when the pitch or roll state of the vehicle that is equal to or more than a prescribed level is determined, keeping on adding the braking force by the braking devices based on the pitch and roll states for a prescribed time makes it possible to reduce excessive fluctuation in the braking force to be added.

Preferably, the pitch and roll determination unit may include a plurality of kinds of determination conditions to determine the pitch and roll states based on rotational acceleration of each of the wheels and the longitudinal acceleration of the vehicle, and an additional moment that is set each time the determination conditions are satisfied may be added up to calculate a total additional moment of the vehicle.

This makes it possible to easily determine the pitch and roll states of the vehicle, and to easily calculate the additional moment.

Specifically, the additional moment that is set each time the determination conditions are satisfied may be a pitch moment toward a rear side of the vehicle, a pitch moment toward a front side of the vehicle, a roll moment with one right wheel of the vehicle running on a protruding road surface, a roll moment with two right wheels of the vehicle running on the protruding road surface, a roll moment with two right wheels and one left wheel of the vehicle running on the protruding road surface, a roll moment with one left wheel of the vehicle running on the protruding road surface, a roll moment with two left wheels of the vehicle running on the protruding road surface, and a roll moment with two left wheels and one right wheel of the vehicle running on the protruding road surface.

This makes it possible to determine a pitch state and a roll state of the vehicle easily and separately, and also makes it possible to determine the roll state easily and accurately in accordance with the running-on state of the vehicle.

Preferably, when a driver of the vehicle performs a prescribed or more braking operation, the pitch and roll control unit may restrain addition of the braking force based on the pitch and roll states.

Accordingly, when the driver performs a sudden braking operation, braking by the pitch and roll control unit can be restrained to give priority to the braking requested by the driver.

Preferably, the vehicle may include a braking control unit that controls the braking force of the braking devices to improve traveling safety of the vehicle, and when the braking control unit executes control of the braking force by the braking devices, the pitch and roll control unit may restrain addition of the braking force based on the pitch and roll states.

Accordingly, during the braking control by the braking control unit, it is possible to restrain braking by the pitch and roll control unit and to preferentially execute control to improve the traveling stability of the vehicle and to improve the traveling safety of the vehicle, such as avoiding collisions, by the braking control unit.

### Advantageous Effects of the Invention

The attitude control device for a vehicle of the present invention can reduce pitch and roll of the vehicle by using detection information by relatively inexpensive detection units that detect wheel rotation speeds and vehicle longitudinal acceleration.

Therefore, for example, for the vehicle having no stroke sensor in a suspension device, the braking force of the four wheels can be controlled in accordance with the attitude of the vehicle so as to appropriately control pitch and roll.

### BRIEF DESCRIPTION OF THE DRAWINGS

FIG. 1 is a schematic block diagram of an attitude control device for a vehicle according to one embodiment of the present invention.

FIG. 2 is an explanatory view of anti-dive force and anti-lift force in a suspension device of a vehicle.

FIG. 3 is an image view of pitch moment generated in the case of running-on of front wheels and additional moment for the pitch moment.

FIG. 4 is an image view of pitch moment generated in the case of running-on of rear wheels and additional moment for the pitch moment.

FIG. 5 is an image view of roll moment generated in the case of running-on of right wheels and additional moment for the roll moment.

FIG. 6 is an image view of roll moment generated in the case of running-on of left wheels and additional moment for the roll moment.

FIG. 7 is a flowchart showing a calculation method of the additional moment in the case of running-on of the front wheels.

FIG. 8 is a flowchart showing a calculation method of the additional moment in the case of running-on of the rear wheels.

FIG. 9 is a flowchart showing a calculation method of the additional moment in the case of running-on of one right wheel.

FIG. 10 is a flowchart showing a calculation method of the additional moment in the case of running-on of two right wheels.

FIG. 11 is a flowchart showing a calculation method of the additional moment in the case of running-on of two right wheels and one left wheel.

FIG. 12 is a flowchart showing a calculation method of the additional moment in the case of running-on of one left wheel.

FIG. 13 is a flowchart showing a calculation method of the additional moment in the case of running-on of two left wheels.

FIG. 14 is a flowchart showing a calculation method of the additional moment in the case of running-on of two left wheels and one right wheel.

FIG. 15 is a flowchart showing a control procedure for determining execution of pitch and roll control.

### MODE FOR CARRYING OUT THE INVENTION

Hereinafter, one embodiment of the present invention is described based on the drawings.

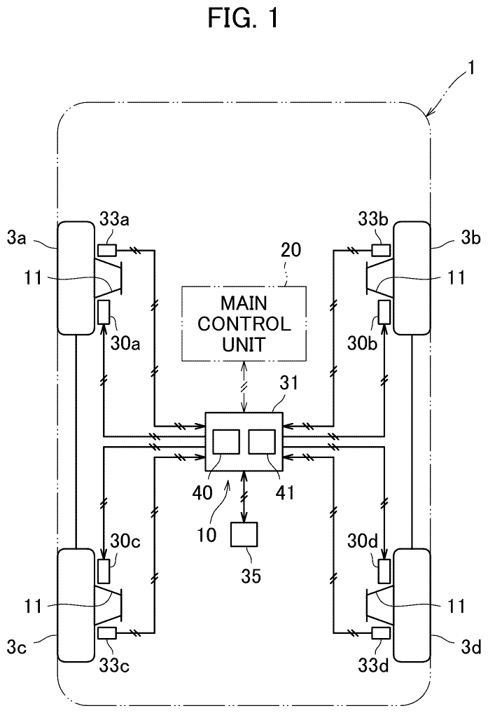

FIG. 1 is a schematic block diagram of an attitude control device 10 for a vehicle according to one embodiment of the present invention.

The attitude control device 10 in one embodiment of the present invention is mounted on a four-wheel vehicle (hereinafter referred to as a vehicle 1) with wheels 3a to 3d (travel wheels) on the front, rear, left, and right sides of a vehicle body. There is an anti-dive and anti-lift geometry between each of the wheels 3a to 3d of the vehicle 1 and the vehicle body, and a suspension device 11 is provided to suspend each of the wheels 3a to 3d to the vehicle body.

The wheels 3a to 3d of the vehicle 1 include brake devices 30a to 30d (braking devices), respectively. The brake devices 30a to 30d are controlled by a brake control unit 31 (braking control unit) so that any different brake force (braking force) can be added to each of the wheels 3a to 3d.

Here, each of the wheels 3a to 3d is driven, for example, by an electric motor or an engine. The present invention is applicable to vehicles with various traveling drive sources, such as plug-in hybrid vehicles or hybrid vehicles that can drive the front wheels 3a and 3b and the rear wheels 3c and 3d separately by an electric motor and can also drive the front wheels 3a and 3b by an engine, electric vehicles that use only an electric motor to drive the wheels 3a to 3d, and engine vehicles that use only the engine to drive the wheels from 3a to 3d, or is applicable to vehicles with various drive modes, such as a four-wheel drive or a two-wheel drive.

The vehicle 1 includes a longitudinal acceleration sensor 35 (longitudinal acceleration detection unit) that detects a longitudinal acceleration of the vehicle body, and also includes wheel speed sensors 33a to 33d (speed detection units) that detect respective rotation speeds of the wheels 3a to 3d.

The attitude control device 10 is constituted of the longitudinal acceleration sensor 35, the wheel speed sensors 33a to 33d of the respective wheels 3a to 3d, and the brake control unit 31.

Here, the present embodiment is configured such that detection values of the longitudinal acceleration sensor 35 and the wheel speed sensors 33a to 33d are input into the brake control unit 31, though the detection values may be input via, for example, a main control unit 20 that controls the entire vehicle.

The brake control unit 31 is configured to include an input/output device, a storage device (such as a ROM, a RAM, and a non-volatile RAM), a central processing unit (CPU), and a timer. The brake control unit 31 receives input of an operation amount of a brake pedal from a brake pedal sensor which is not illustrated, and controls the braking force (brake force) by the brake devices 30a to 30d based on the operation amount of the brake pedal or the like.

The brake control unit 31 also receives input of detection information from the longitudinal acceleration sensor 35 and the wheel speed sensors 33a to 33d. The attitude control device 10 includes a pitch and roll determination unit 40 that estimates the attitude of the vehicle 1, that is, the pitch and roll states of the vehicle 1 to be more specific, based on the detection information from the longitudinal acceleration sensor 35, and the wheel speed sensors 33a to 33d of the respective wheels 3a to 3d. The attitude control device 10 also includes an additional braking force calculation unit 41 (pitch and roll control unit) that calculates the brake force added to each of the wheels 3a to 3d to reduce the estimated pitch and roll. The attitude control device 10 executes pitch and roll control that estimates the pitch and roll of the vehicle based on the detection information from the longitudinal acceleration sensor 35 and the wheel speed sensors 33a to 33d, and sets the brake force added to each of the wheels 3a to 3d to reduce the pitch and roll.

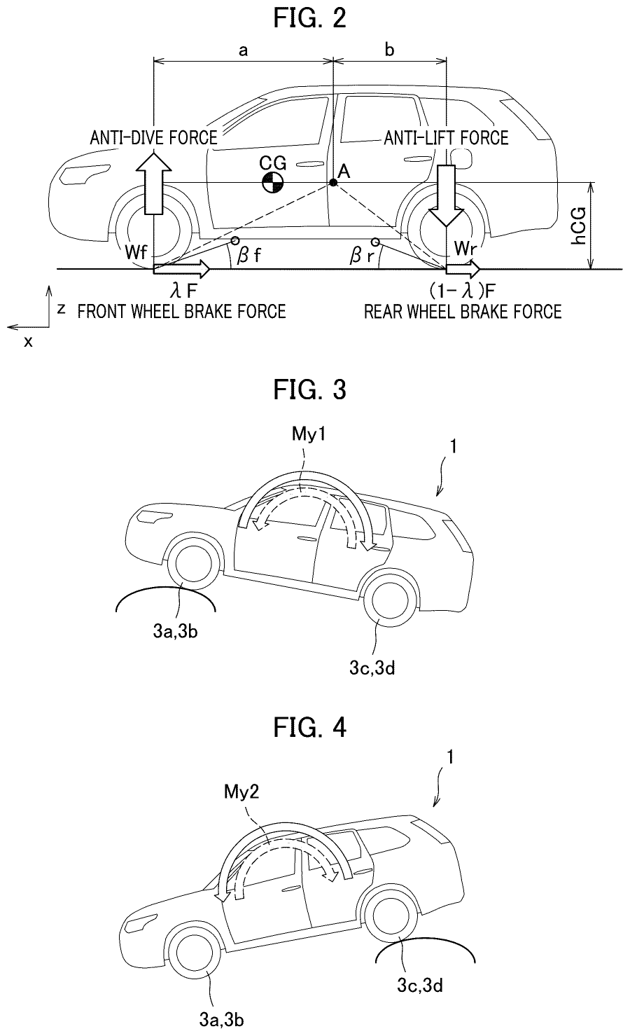

FIG. 2 is an explanatory view of anti-dive force and anti-lift force.

First, the relationship between the anti-dive and anti-lift forces in the suspension device of the vehicle 1 and the pitch and roll moments is described.

As shown in FIG. 2, when the distance between ground points of the front wheels 3a and 3b of the vehicle 1 and the center of gravity A of the vehicle body in a front-rear direction of the vehicle is a, the distance between ground points of the rear wheels 3c and 3d of the vehicle 1 and the center of gravity A in the front-rear direction of the vehicle is b, the height of the center of gravity from the ground is hCG, the overall brake force of the vehicle is F, a ratio of the brake force at the side of the front wheels 3a and 3b is λ, an anti-lift angle is βf, and an anti-dive angle is βr, a pitch moment My that is the sum of a pitch moment generated by the deceleration of the vehicle 1 and a pitch moment generated by the anti-dive force and the anti-lift force of the suspension device 11 is obtained by (Equation 1) below.

$$My = F \times hCG - ( λ F \times \vert tan ( β f ) \times a + ( 1 - λ ) F \times \vert tan ( β r ) \vert \times b ) \qquad ( Equation 1 )$$

When a front track (the distance between the left and right front wheels 3a and 3b) is tf, a rear track (the distance between the left and right rear wheels 3c and 3d) is tr, the braking force (brake force) of a left front wheel 3a is Fbfl, the braking force of the right front wheel 3b is Fbfr, the braking force of the left rear wheel 3c is Fbrl, and the braking force of the right rear wheel 3d is Fbrr, a roll moment Mx generated by the anti-dive and anti-lift forces of the suspension device 11 is obtained by (Equation 2) below:

$$MX = tf / 2 ( Fbfl - Fbfr ) \times tan ( β f ) + tr / 2 ( - Fbrl - Fbrr ) \times tan ( β r ) \qquad ( Equation 2 )$$

FIGS. 3 to 6 are image views of additional moment in the attitude control device 10 of the present embodiment. FIGS. 3 and 4 are image views of pitch moment and additional moment corresponding thereto, generated in the case of running-on of the front wheels 3a and 3s and in the case of running-on of the rear wheels 3c and 3d, respectively.

As shown by a solid arrow line in FIG. 3, the pitch moment generated when the front wheels 3a and 3b of the vehicle 1 runs on a protruding road surface is the moment that rotates backward around the center of gravity of the vehicle 1. To cope with the moment, the attitude control device 10 may add an additional pitch moment My1, which rotates toward the front side of the vehicle as indicated by a dashed arrow line to cancel out this pitch moment.

As shown by a solid arrow line in FIG. 4, the pitch moment generated when the rear wheels 3c and 3d of the vehicle 1 run on the protruding road surface is the moment that rotates forward around the center of gravity of the vehicle 1. To cope with the moment, the attitude control device 10 may add an additional pitch moment My2, which rotates toward the rear side of the vehicle as indicated by a dashed arrow line to cancel out the pitch moment.

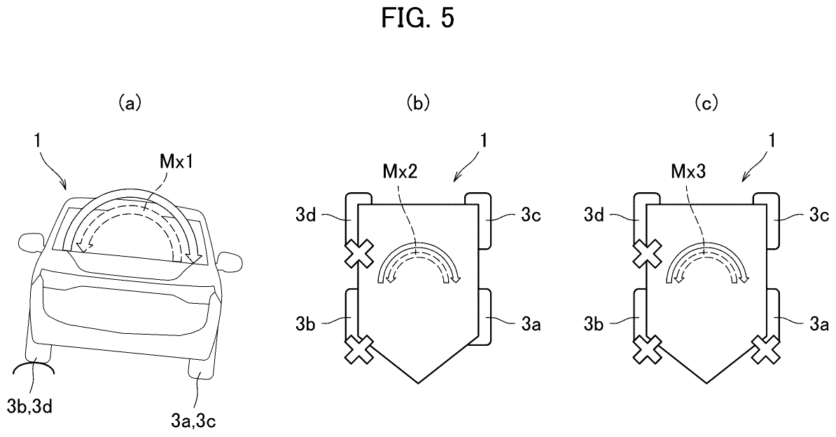

As shown by solid arrow lines in FIG. 5, the roll moment generated when the right wheels 3b and 3d of the vehicle 1 run on the protruding road surface is the moment that rotates leftward in a vehicle width direction around the center of gravity of the vehicle 1. As shown in FIG. 5, following cases are considered: (a) the case where only one wheel (for example, the right front wheel 3b) runs on the protruding road surface; (b) the case where two wheels (the right front wheel 3b and the right rear wheel 3d) run on the protruding road surface; and (C) the case where three wheels (the right front wheel 3b, the right rear wheel 3d, and, for example, the left front wheel 3a) run on the protruding road surface.

Therefore, in the cases (a) to (c) in FIG. 5, additional roll moments Mx1, Mx2, and Mx3 may be added so as to cancel out the roll moment as shown by dashed lines in FIG. 5. The additional roll moment Mx1 is used in the case (a) in FIG. 5, the additional roll moment Mx2 is used in the case (b), and the additional roll moment Mx3 is used in the case (c).

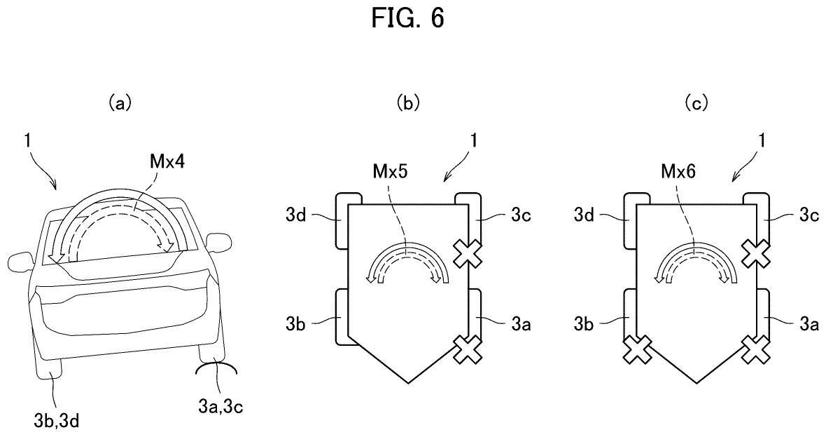

As shown by solid arrow lines in FIG. 6, the roll moment generated when the left wheels 3a and 3c of the vehicle 1 run on the protruding road surface is the moment that rotates rightward in the vehicle width direction around the center of gravity of the vehicle 1. As shown in FIG. 6, following cases are considered: (a) the case where only one wheel (for example, the left front wheel 3a) runs on the protruding road surface; (b) the case where two wheels (the left front wheel 3a and the left rear wheel 3c) run on the protruding road surface; and (c) the case where three wheels (the left front wheel 3a, the left rear wheel 3c, and, for example, the right front wheel 3b) run on the protruding road surface.

Therefore, in the cases (a) to (c), additional roll moments Mx4, Mx5, and Mx6 may be added so as to cancel out the roll moment as shown by dashed lines in FIG. 6. The additional roll moment Mx4 is used in the case (a), the additional roll moment Mx5 is used in the case (b), and the additional roll moment Mx6 is used in the case (c) in FIG. 6.

In the cases (b) and (c) in FIGS. 5 and 6, cross marks indicate running on the protruding road surface. Although in the cases (b) and (c) in FIGS. 5 and 6, the arrow lines representing moments are placed on the top views, the moments are roll moments in a longitudinal direction similar to (a) in actuality.

Description is given of a method of determining the attitude of the vehicle 1, which is executed in the brake control unit 31.

The pitch and roll determination unit 40 in the brake control unit 31 determines the attitude in each of the pitch and roll described above, based on the longitudinal acceleration of vehicle 1 and the wheel rotation speeds of the respective wheels 3a to 3d.

As shown in FIG. 3, the attitude of the vehicle 1 with the front wheels 3a and 3b running on the protruding road surface is the attitude when a condition in Table 1 below is satisfied.

The condition in Table 1 is to satisfy all five conditions: the rotational accelerations of the left and right front wheels 3a and 3b exceed prescribed thresholds (FRwa>Xwa1, FLwa>Xwa2); wheel rotational accelerations of the left and right rear wheels 3c and 3d are less than prescribed thresholds (|wsaRL|<Xwa3, |wsaRR|<Xwa4); and the longitudinal acceleration of the vehicle exceeds a prescribed threshold (La<Xaa1).

The attitude of the vehicle 1 with the rear wheels 3c and 3d running on the protruding road surface as shown in FIG. 4 is the attitude when a condition in Table 2 below is satisfied.

The condition in Table 2 is to satisfy all five conditions below: the rotational accelerations of the left and right rear wheels 3c and 3d exceed prescribed thresholds (FLwa>Xwa5, RRwa>Xwa6); wheel rotational accelerations of the left and right front wheels 3a and 3b are less than prescribed thresholds (|wsaFL|<Xwa7, |wsaFR| <Xwa8); and the longitudinal acceleration of the vehicle exceeds a prescribed threshold (La<Xaa2).

The attitude of the vehicle 1 with one right wheel of the vehicle 1 running on the protruding road surface as shown in (a) in FIG. 5 is the attitude when a condition in Table 3 below is satisfied.

The condition in Table 3 is to satisfy all five conditions below: the rotational acceleration of the right front wheel 3b exceeds a prescribed threshold (FRwa>Xwa9); wheel rotational accelerations of other wheels 3a, 3c and 3d are less than prescribed thresholds (|wsaFL|<Xwa10, |wsaRL|<Xwa11, |wsaRL|<Xwa12); and the longitudinal acceleration of the vehicle exceeds a prescribed threshold (La<Xaa3). Alternatively, the condition in Table 3 is satisfied when five conditions below are all satisfied: the rotational acceleration of the right rear wheel 3d exceeds a prescribed threshold (RRwa>Xwa13); wheel rotational accelerations of other wheels 3a, 3b and 3c are less than prescribed thresholds (|wsaFR|<Xwa14, |wsaFL|<Xwa15, |wsaRL|<Xwa16); and the longitudinal acceleration of the vehicle exceeds a prescribed threshold (La<Xaa4).

The attitude of the vehicle 1 with two right wheels 3b and 3d running on the protruding road surface as shown in (b) in FIG. 5 is the attitude when a condition in Table 4 below is satisfied.

The condition in Table 4 is to satisfy all five conditions below: the rotational accelerations of the two right wheels 3b and 3d exceed prescribed thresholds (FRwa>Xwa17, RRwa>Xwa18); wheel rotational accelerations of the two left wheels 3a and 3c are less than prescribed thresholds (|wsaFL|<Xwa19, |wsaRL|<Xwa20); and the longitudinal acceleration of the vehicle exceeds a prescribed threshold (La<Xaa5).

The attitude of the vehicle 1 with two right wheels and one left wheel of the vehicle 1 running on the protruding road surface as shown in (c) in FIG. 5 is the attitude when a condition in Table 5 below is satisfied.

The condition in Table 5 is to satisfy all five conditions below: the rotational accelerations of the left and right front wheels 3a and 3b exceed prescribed thresholds (FLwa>Xwa21, FRwa>Xwa22); the rotational acceleration of the right rear wheel 3d exceeds a prescribed threshold (RRwa>Xwa23); rotational acceleration of the left rear wheel 3c is less than a prescribed threshold (|wsaRL|<Xwa24); and the longitudinal acceleration of the vehicle exceeds a prescribed threshold (La<Xaa6).

The attitude of the vehicle 1 with one left wheel running on the protruding road surface as shown in (a) in FIG. 6 is the attitude when a condition in Table 6 below is satisfied.

The condition in Table 6 is to satisfy all five conditions below: the rotational acceleration of the left front wheel 3a exceeds a prescribed threshold (FLwa>Xwa25); rotational accelerations of other wheels 3b, 3c and 3d are less than prescribed thresholds (|wsaFR|<Xwa26, |wsaRL|<Xwa27, |wsaRR|<Xwa28); and the longitudinal acceleration of the vehicle exceeds a prescribed threshold (La<Xaa7). Alternatively, the condition in Table 6 is satisfied when five conditions below are all satisfied: the rotational acceleration of the left rear wheel 3c exceeds a prescribed threshold (RLwa>Xwa29); rotational accelerations of other wheels 3a, 3b and 3d are less than prescribed thresholds (|wsaFR|<Xwa30, |wsaFL|<Xwa31, |wsaRR|<Xwa32); and the longitudinal acceleration of the vehicle exceeds a prescribed threshold (La<Xaa8).

The attitude of the vehicle 1 with two left wheels 3a and 3c running on the protruding road surface as shown in (b) in FIG. 6 is the attitude when a condition in Table 7 below is satisfied.

The condition in Table 7 is to satisfy all five conditions below: the rotational accelerations of the left wheels 3a and 3c exceed prescribed thresholds (FLwa>Xwa33, RLwa>Xwa34); rotational accelerations of the two right wheels 3b and 3d are less than prescribed thresholds (|wsaFR|<Xwa35, |wsaRR|<Xwa36); and the longitudinal acceleration of the vehicle exceeds a prescribed threshold (La<Xaa9).

The attitude of the vehicle 1 with two left wheels 3a and 3c and one right wheel running on the protruding road surface as shown in (c) in FIG. 6 is the attitude when a condition in Table 8 below is satisfied. The condition in Table 8 is to satisfy all five conditions below: the rotational accelerations of the front wheels 3a and 3b exceed prescribed thresholds (FRwa>Xwa37, FLwa>Xwa38); the acceleration of the left rear wheel 3c exceeds a prescribed threshold (RLwa>Xwa39); the rotational acceleration of the right rear wheel 3d is less than a prescribed threshold (|wsaRR|<Xwa40); and the longitudinal acceleration of the vehicle exceeds a prescribed threshold (La<Xaa10).

Note that the thresholds Xwa1 to Xwa40 and Xaa1 to Xaa10 are each set as appropriate.

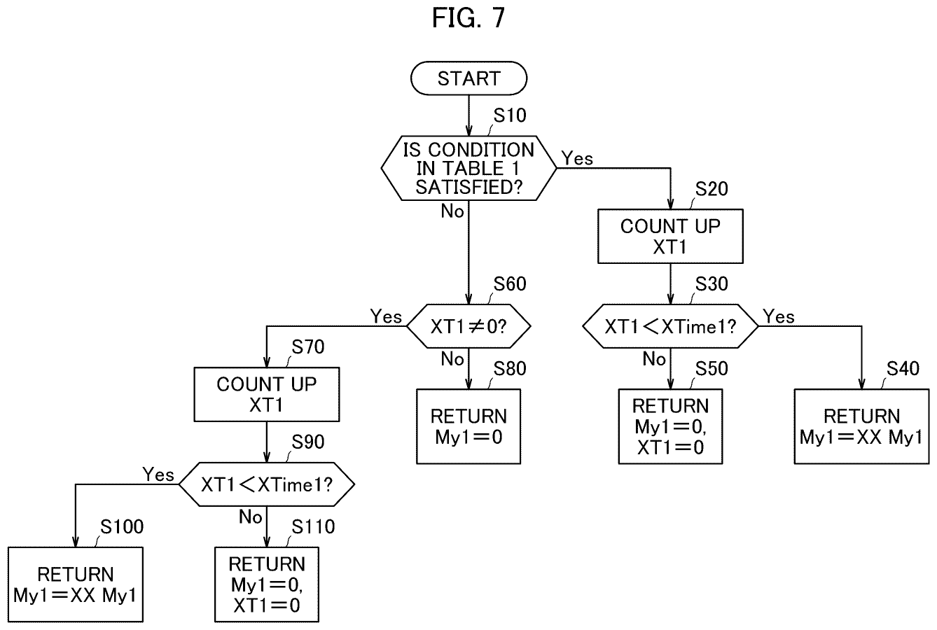

FIGS. 7 to 14 are flowcharts showing calculation methods of the additional pitch moments My1 and My2, and the additional roll moments Mx1 to Mx6.

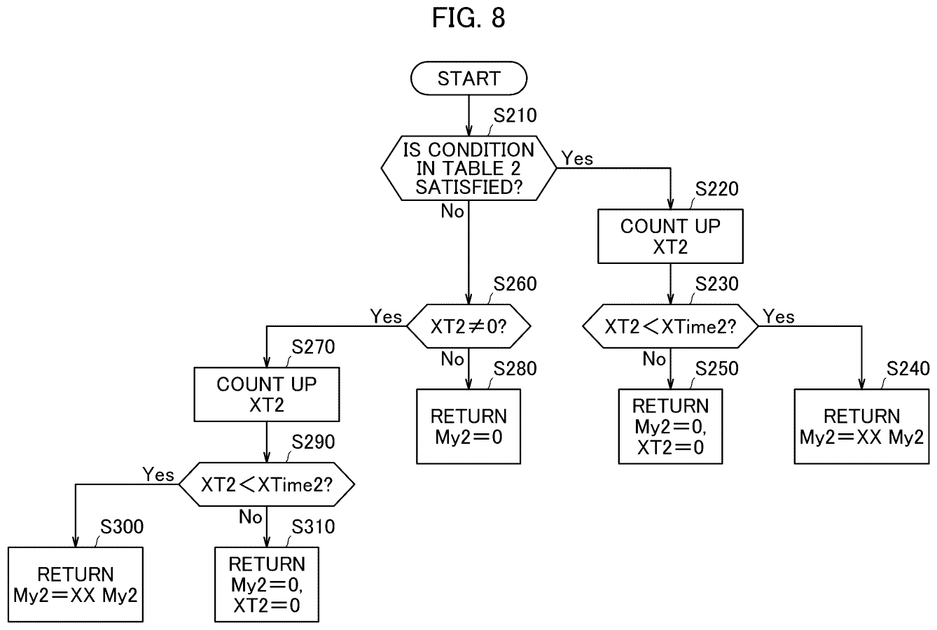

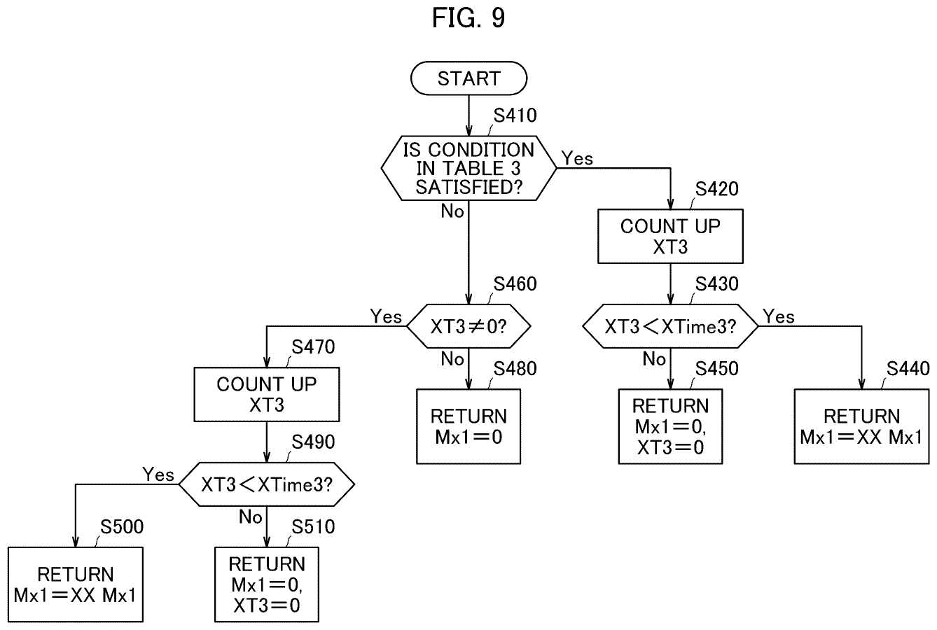

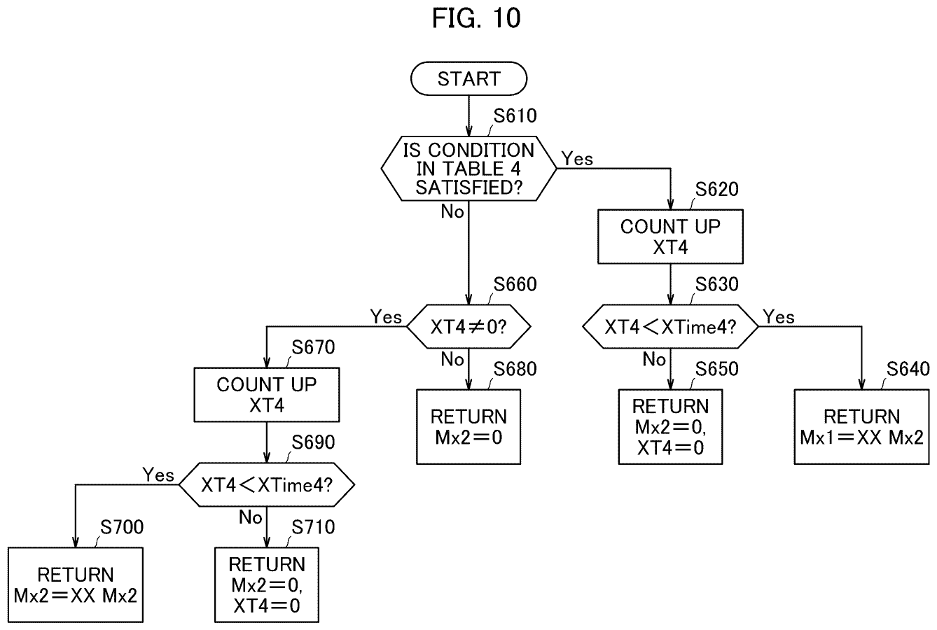

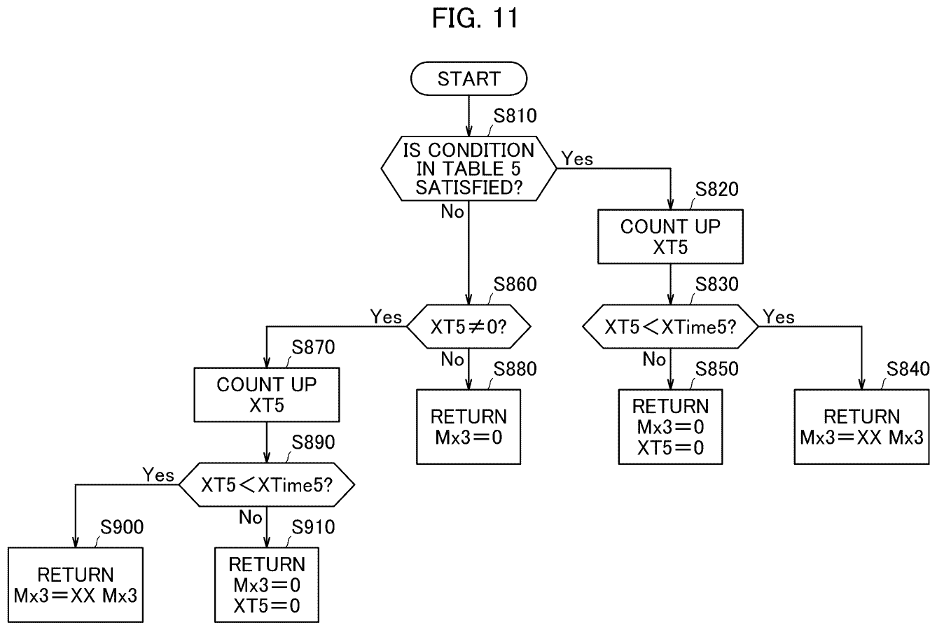

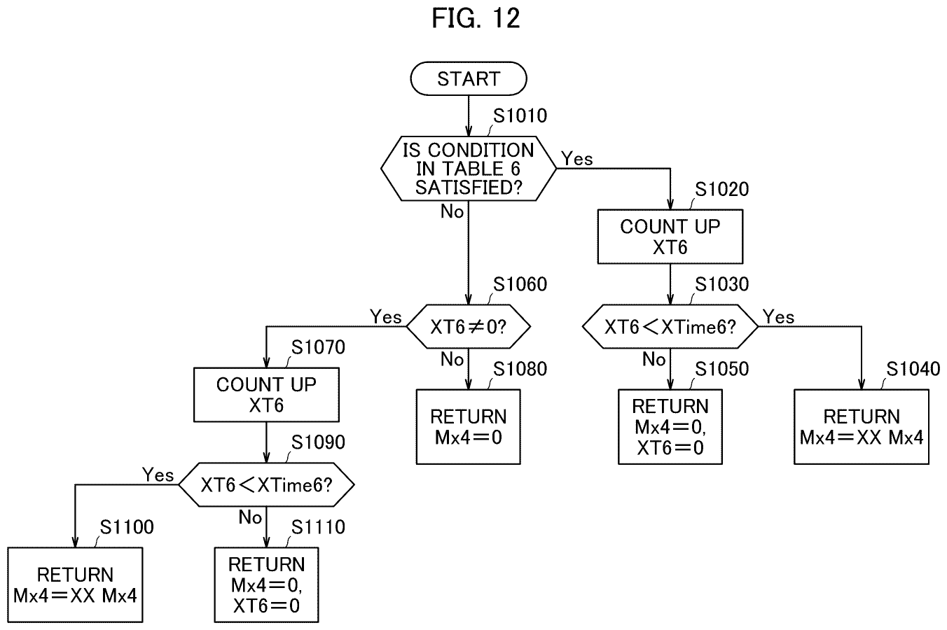

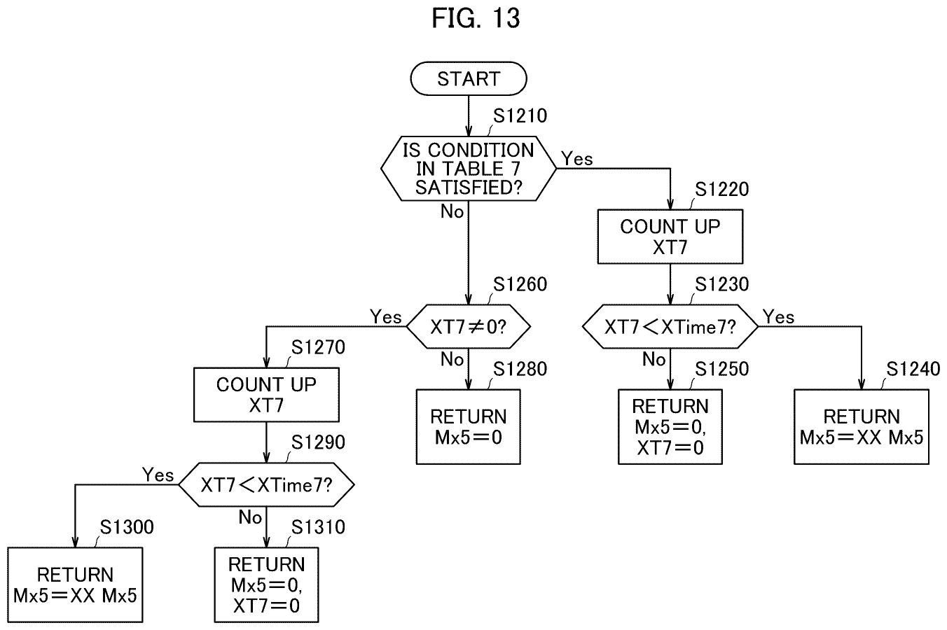

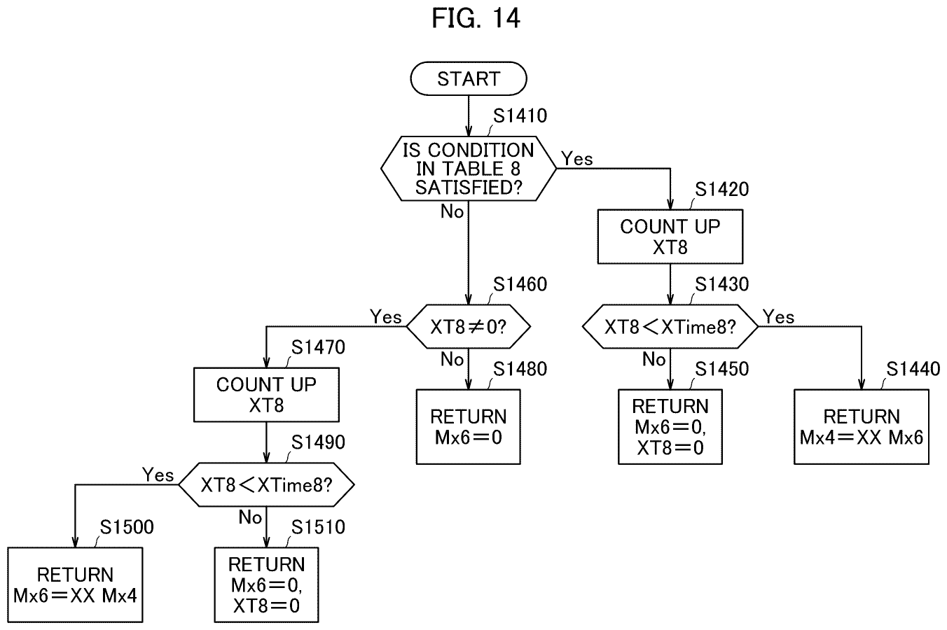

FIG. 7 shows a calculation method of the additional pitch moment My1 in the case of running-on of the front wheels 3a and 3b, FIG. 8 shows a calculation method of the additional pitch moment My2 in the case of running-on of the rear wheels 3c and 3d, FIG. 9 shows a calculation method of the additional roll moment Mx1 in the case of running-on of one right wheel, FIG. 10 shows a calculation method of the additional roll moment Mx2 in the case of running-on of two right wheels, FIG. 11 shows a calculation method of the additional roll moment Mx3 in the case of running-on of the two right wheels and one left wheel, FIG. 12 shows a calculation method of the additional roll moment Mx4 in the case of running-on of one left wheel, FIG. 13 shows a calculation method of the additional roll moment Mx5 in the case of running-on of two left wheels, and FIG. 14 shows a calculation method of the additional roll moment Mx6 in the case of running-on of two left wheels and one right wheel.

These flowcharts are each repeatedly executed with a short control cycle (e.g., a cycle of about a few milliseconds).

As shown in FIG. 7, first, in step S10, it is determined whether or not the condition in Table 1 is satisfied. When the condition in Table 1 is satisfied, the processing proceeds to step S20. when the condition in Table 1 is not satisfied, the processing proceeds to step S60.

In step S20, a brake timer XT1 is made to count up. Then, the processing proceeds to step S30.

In step S30, it is determined whether or not the value of the brake timer XT1 is less than a braking time threshold XTime1, which is set as appropriate. When the value of the brake timer XT1 is less than the braking time threshold XTime1, the processing proceeds to step S40. When the value of the brake timer XT1 is equal to or more than the braking time threshold XTime1, the processing proceeds to step S50.

In step S40, the additional pitch moment My1 is set to xxMy1 that is set as appropriate. The present routine is then returned.

In step S50, the additional pitch moment My1 is set to 0 and the brake timer XT1 is set to 0. The present routine is then returned.

In step S60, whether or not the brake timer XT1 is not zero is determined. When the brake timer XT1 is not 0, the processing proceeds to step S70. When the brake timer XT1 is 0, the processing proceeds to step S80,

In step S70, the brake timer XT1 is made to count up. Then, the processing proceeds to step S90.

In step S80, the additional pitch moment My1 is set to 0. The present routine is then returned.

In step S90, it is determined whether or not the value of the brake timer XT1 is less than the braking time threshold XTime1. When the value of the brake timer XT1 is less than the braking time threshold XTime1, the processing proceeds to step S100, When the value of the brake timer XT1 is equal to or more than the braking time threshold XTime1, the processing proceeds to step S110,

In step S100, the additional pitch moment My1 is set to xxMy1. The present routine is then returned. In step S110, the additional pitch moment My1 is set to 0 and the brake timer XT1 is set to 0. The present routine is then returned.

Under the control as described above, when the condition in Table 1 is satisfied, the additional pitch moment My1 is set to xxMy1 until the brake timer XT1 reaches the braking time threshold XTime1.

As shown in FIG. 8, the additional pitch moment My2 is set in the same way as the additional pitch moment My1.

Specifically, when the condition in Table 2 is satisfied, the additional pitch moment My2 is set to xxMy2 until a brake timer XT2 reaches a braking time threshold XTime2.

The additional roll moment Mx1 is also set in the same way as the additional pitch moment My1 as shown in FIG. 9.

Specifically, when the condition in Table 3 is satisfied, the additional roll moment Mx1 is set to xxMx1 until a brake timer XT3 reaches a braking time threshold XTime3.

The additional roll moments Mx2, Mx3, Mx4, Mx5, and Mx6 are set in the same way as the additional roll moment Mx1 as shown in FIGS. 10, 11, 12, 13, and 14, respectively.

The pitch moment My and the roll moment Mx of the vehicle 1 that are added at the end are calculated by following (Equation 3) and (Equation 4):

$$My = My 1 + My 2 \qquad ( Equation 3 )$$

$$Mx = Mx 1 + Mx 2 + Mx 3 + Mx 4 + Mx 5 + Mx 6 \qquad ( Equation 4 )$$

Next, the additional braking forces Fbfl, Fbfr, Fbrl, and Fbrr of the respective wheels are calculated from the values of the additional moments. As calculation expressions relating to the additional moments, (Equation 5) and (Equation 6) are obtained by deforming (Equation 1) and (Equation 2) described above:

$$[ Expression 1 ]$$

$$( {F}_{bfl} + {F}_{bfr} + {F}_{brl} + {F}_{brr} ) \times hCG - ( ( {F}_{bfl} + {F}_{bfr} ) \times \vert tan ( β f ) \vert \times a + ( {F}_{brl} + {F}_{brr} ) \times \vert tan ( β r ) \vert \times b ) = My \qquad ( Equation 5 )$$

$$[ Expression 2 ]$$

$$\frac{{t}_{f}}{2} ( {F}_{bfl} - {F}_{bfr} ) \times tan ( β f ) + \frac{{t}_{r}}{2} ( - {F}_{brl} + {F}_{brr} ) \times tan ( β r ) = {M}_{x} \qquad ( Equation 6 )$$

X Total Force(=XXForce) that is the total additional braking force is obtained from (Equation 7) below. X Dif Force that is the difference between left and right additional braking forces is obtained from (Equation 8) below:

$$[ Expression 3 ]$$

$${F}_{bfl} + {F}_{bfr} + {F}_{brl} + {F}_{brr} = X\_Total \_Force \qquad ( Equation 7 )$$

$$[ Expression 4 ]$$

$${F}_{bfl} - {F}_{bfr} + {F}_{brl} - {F}_{brr} = X\_Dif \_Force \qquad ( Equation 8 )$$

Here, X DiF Force=XX DiF X required yaw moment input from the main control unit 20, and XX DiF is a gain of the required yaw moment that is set as appropriate.

When the pitch moment My, the roll moment Mx, the total additional braking force X Total Force, and the difference between left and right additional braking forces X Dif Force are matrixed, (Equation 9) below is obtained.

$$[ Expression 5 ]$$

$$A \times B = C \qquad ( Equation 9 )$$

$$A = [ \begin{matrix}\begin{matrix}hCG - \\ \vert tan ( β f ) \vert \times a\end{matrix} & \begin{matrix}hCG - \\ \vert tan ( β f ) \vert \times a\end{matrix} & \begin{matrix}hCG - \\ \vert tan ( β r ) \vert \times b\end{matrix} & \begin{matrix}hCG - \\ \vert tan ( β r ) \vert \times b\end{matrix} \\ \frac{{t}_{f}}{2} \times tan ( β f ) & - \frac{{t}_{f}}{2} \times tan ( β f ) & - \frac{{t}_{r}}{2} \times tan ( β r ) & \frac{{t}_{r}}{2} \times tan ( β r ) \\ 1 & 1 & 1 & 1 \\ 1 & - 1 & 1 & - 1\end{matrix} ] \\ B = [ \begin{matrix}{F}_{bfl} \\ {F}_{bfr} \\ {F}_{brl} \\ {F}_{brr}\end{matrix} ] \\ C = [ \begin{matrix}{M}_{y} \\ {M}_{x} \\ X\_Total \_Force \\ X\_Dif \_Force\end{matrix} ]$$

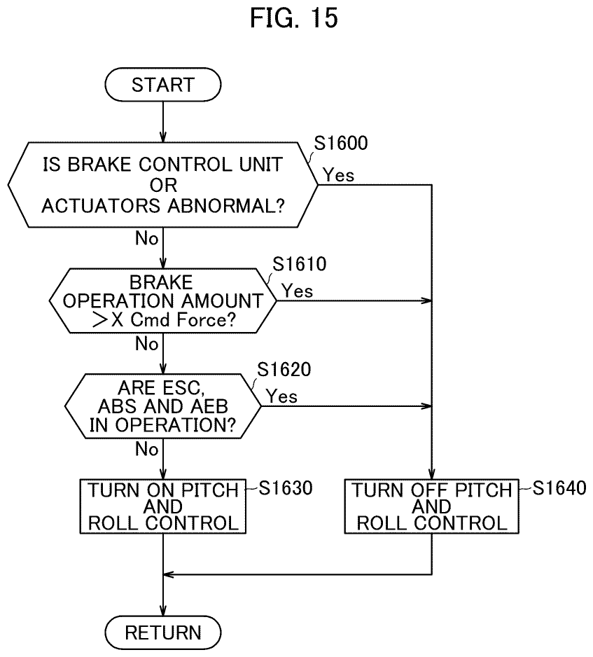

FIG. 15 is a flowchart showing a control procedure for determining execution of the pitch and roll control. The control shown in FIG. 15 is initiated at system start-up and is repeatedly performed while the vehicle 1 is traveling.

First, in step S1600, it is determined whether or not the brake control unit 31 or each of the brake devices 30a to 30d is in an abnormal (failed) state. Whether or not these units are abnormal can be determined by a publicly known self-diagnostic function. When the brake control unit 31 or each of the brake devices 30a to 30d is abnormal, the processing proceeds to step S1640. When the brake control unit 31 and each of the brake devices 30a to 30d are normal, the processing proceeds to step S1610,

In step S1610, it is determined whether or not the brake operation amount (operating force) of a driver exceeds a prescribed threshold X Cmd Force that is set as appropriate. When the brake operation amount exceeds the threshold X Cmd Force, the processing proceeds to step S1640. When the brake operation amount is equal to or less than the threshold X Cmd Force, the processing proceeds to step S1620.

In step S1620, it is determined whether or not any other travel control device (travel safety device) of the vehicle 1, such as an ESC (electric stability control system), an anti-lock brake system (ABS), and an autonomous emergency braking (AEB), is in operation (is executed). When these other travel control devices are in operation, the processing proceeds to step S1640. When these other travel control devices are not in operation (are in standby state), the processing proceeds to step S1630.

In step S1630, the pitch and roll control by the attitude control device 10 is turned on. The present routine is then returned.

In step S1640, the pitch and roll control by the attitude control device 10 is turned off. The present routine is then returned.

As described in the foregoing, in the present embodiment, it becomes possible to implement the attitude control (pitch and roll control) for controlling the braking force of the brake devices 30a to 30d for the four wheels of the vehicle 1 to reduce the pitch and roll of the vehicle 1.

The current pitch and roll of the vehicle 1 are estimated based on the rotational acceleration of each of the wheels 3a to 3d and the longitudinal acceleration of the vehicle 1. This makes it possible to estimate the pitch and roll of the vehicle 1 based on the detection information from relatively inexpensive detectors, such as the four wheel speed sensors 33a to 33d, and the longitudinal acceleration sensor 35.

The pitch and roll determination unit 40 includes the tables 1 to 8 having determination conditions for determining the pitch and roll states of the vehicle 1 based on the rotational acceleration of each of the wheels 3a to 3d and the longitudinal acceleration of the vehicle 1, and determines whether or not the condition of each of the tables 1 to 8 is satisfied.

When the condition of any one of the tables 1 to 8 is satisfied, the additional braking force calculation unit 41 sets the additional moments Mx1, Mx2, and My1 to My6 corresponding to each table, and adds up these additional moments to calculate the total additional moment for the vehicle 1.

This makes it possible to easily determine the pitch and roll states of the vehicle 1, and to easily calculate the additional moment.

The details of the additional moments My1, My2, and Mx1 to Mx6 that are set for each of the tables 1 to 8 are as follows.
The table 1 includes conditions to determine generation of a pitch moment toward the rear side of the vehicle to set the additional pitch moment My1 toward the front side of the vehicle.
The table 2 includes conditions to determine generation of a pitch moment toward the front side of the vehicle to set the additional pitch moment My2 toward the rear side of the vehicle.
The table 3 includes conditions to determine generation of a roll moment with one right wheel of the vehicle 1 running on a protruding road surface to set the additional pitch moment Mx1 toward the right side of the vehicle.
The table 4 includes conditions to determine generation of a roll moment with two right wheels of the vehicle running on the protruding road surface to set the additional pitch moment Mx2 toward the right side of the vehicle.
The table 5 includes conditions to determine generation of a roll moment with two right wheels and one left wheel of the vehicle running on the protruding road surface to set the additional pitch moment Mx3 toward the right side of the vehicle.
The table 6 includes conditions to determine generation of a roll moment with one left wheel of the vehicle running on the protruding road surface to set the additional pitch moment Mx4 toward the left side of the vehicle.
The table 7 includes conditions to determine generation of a roll moment with two left wheels of the vehicle running on the protruding road surface to set the additional pitch moment Mx5 toward the left side of the vehicle.
The table 8 includes conditions to determine generation of a roll moment with two left wheels and one right wheel of the vehicle running on the protruding road surface to set the additional pitch moment Mx6 toward the left side of the vehicle.

This makes it possible to easily and accurately determine the pitch and roll states of the vehicle 1 based on the rotation speed of each of the wheels 3a to 3d and the longitudinal acceleration of the vehicle 1.

The determination in each of the tables 1 to 8, based on the rotational acceleration of each of the wheels 3a to 3d and the longitudinal acceleration of the vehicle 1, is performed in a relatively short cycle to swiftly respond to attitude change of the vehicle 1. However, as shown in the left part of the flowchart in each of FIGS. 7 to 14, once the determination condition of each of the tables 1 to 8 is satisfied and the brake timer is made to count up and indicates a value other than 0, the additional moments corresponding to the pertinent tables 1 to 8 are continuously set until the count up of the brake timer is completed, even when it is determined in the middle of counting that the determination conditions of the pertinent tables 1 to 8 are not satisfied.

As a result, sufficient responsiveness in the case where the determination condition in each of the table 1 to 8 is satisfied is secured, and once the determination condition is satisfied, the additional moment is set, and addition of the braking force is maintained for a prescribed period of time until the count up of the brake timer is completed. This makes it possible to restrain excessive fluctuation (switching) of the braking force to be added.

In any one of the case where the brake control unit 31 or each of the brake devices 30a to 30d is abnormal, the case where the brake operation amount of a driver exceeds the threshold X Cmd Force, and the case where any travel control device (travel safety device), namely, ESC, ABS, and AEB, other than the attitude control device 10, is in operation, the attitude control device 10 does not execute the pitch and roll control.

When the brake operation force is more than a prescribed value in particular, the pitch and roll control is not executed, and therefore when the driver performs a sudden brake operation, it is possible to restrain the pitch and roll control of the present embodiment to give priority to the braking by the brake operation.

When any travel control device other than the attitude control device is in operation (such as during brake control), it is possible to restrain the pitch and roll control of the present embodiment to give priority to other travel control devices, and to secure the travel safety function thereby appropriately by the other travel control devices.

This concludes the description of the embodiment, though the mode of the present invention is not limited to the embodiment disclosed. For example, in the above embodiment, when the brake operation amount exceeds the threshold X Cmd Force, or when other travel control devices are in operation, the pitch and roll control of the present embodiment is not executed. However, the braking force may be reduced and added under the pitch and roll control of the present embodiment.

The present invention is widely applicable to vehicles capable of independently braking the front, rear, left, and right four wheels.

### EXPLANATION OF REFERENCE SIGNS

1 vehicle
3a to 3d wheels
10 attitude control device
11 suspension device
30a to 30d brake device (braking device)
31 brake control unit (braking control unit)
33a to 33d wheel speed sensor (speed detection unit)
35 longitudinal acceleration sensor (longitudinal acceleration detection unit)
40 pitch and roll determination unit
41 additional braking force calculation unit (pitch and roll control unit)

1.-6. (canceled)

7. An attitude control device for a vehicle,
provided in a vehicle having front, rear, left, and right wheels suspended by a suspension device that has an anti-dive and anti-lift geometry, the attitude control device comprising:
braking devices provided for the respective front, rear, left, and right wheels;
a braking control unit that operates and controls the front, rear, left, and right braking devices to allow addition of braking force independently to the front, rear, left, and right wheels;
speed detection units that detect respective rotation speeds of the front, rear, left, and right wheels; and
a longitudinal acceleration detection unit that detects a longitudinal acceleration of the vehicle, wherein
the braking control unit includes
a pitch and roll determination unit that determines pitch and roll states of the vehicle based on the rotation speed of each of the wheels and the longitudinal acceleration of the vehicle, and
a pitch and roll control unit that controls each of the front, rear, left, and right braking devices to add braking force based on the pitch and roll states, and
the pitch and roll determination unit includes a plurality of kinds of determination conditions to determine the pitch and roll states based on rotational acceleration of each of the wheels and the longitudinal acceleration of the vehicle, and an additional moment that is set each time the determination conditions are satisfied is added up to calculate a total additional moment of the vehicle.

8. The attitude control device for a vehicle according to claim 7, wherein
when the pitch and roll determination unit determines the pitch or roll state of the vehicle that is equal to or more than a prescribed level while the vehicle is traveling, the pitch and roll control unit maintains addition of the braking force by the braking devices based on the pitch and roll states for a prescribed time.

9. The attitude control device for a vehicle according to claim 7, wherein
the additional moment that is set each time the determination conditions are satisfied is
a pitch moment toward a rear side of the vehicle,
a pitch moment toward a front side of the vehicle,
a roll moment with one right wheel of the vehicle running on a protruding road surface,
a roll moment with two right wheels of the vehicle running on the protruding road surface,
a roll moment with two right wheels and one left wheel of the vehicle running on the protruding road surface,
a roll moment with one left wheel of the vehicle running on the protruding road surface, a roll moment with two left wheels of the vehicle running on the protruding road surface, and
a roll moment with two left wheels and one right wheel of the vehicle running on the protruding road surface.

10. The attitude control device for a vehicle according to claim 7, wherein
when a driver of the vehicle performs a prescribed or more braking operation, the pitch and roll control unit restrains addition of the braking force based on the pitch and roll states.

11. The attitude control device for a vehicle according to claim 7, wherein
the vehicle includes a braking control unit that controls the braking force of the braking devices to improve traveling safety of the vehicle, and
when the braking control unit executes control of the braking force by the braking devices, the pitch and roll control unit restrains addition of the braking force based on the pitch and roll states.
